(19) United States
(12) Patent Application Publication
(10) Pub. No.: US 2026/0191167 A1
(43) Pub. Date: Jul. 9, 2026

(54) Animal Feeder

(71) Applicant: Laura Rutschman, Dodge City, KS (US)

(72) Inventor: Laura Rutschman, Dodge City, KS (US)

(21) Appl. No.: 19/555,609

(22) Filed: Mar. 3, 2026

(51) Int. Cl. A01K 5/01

(52) U.S. Cl. CPC A01K 5/01

(57) ABSTRACT

A tub feeder for feeding horses, the tub feeder incorporating an annularly extending sidewall which has upper and lower ends; the tub feeder further incorporating an upper opening defined by the upper end of the annularly extending sidewall, the upper opening having a diameter greater than 18 inches; the tub feeder further incorporating a truss supporting the annularly extending sidewall's lower end, wherein the truss includes a planar top chord and a downwardly curved bottom chord; the tub feeder further incorporating ballast fill between the top and bottom chords.

### FIELD OF THE INVENTION

This invention relates to upwardly opening vessels which are adapted for feeding of animals. More particularly, the instant invention relates to such vessels which include a tub configuration.

### BACKGROUND OF THE INVENTION

Upwardly opening vessels such as horse feeding bins or tubs are commonly utilized within a horse stableyard, pasture or corral. Such feeding tubs are commonly placed directly upon the ground, allowing animals such as horses to view the contents of the tub from areas in proximity with the tub, and to downwardly extend its mouth and muzzle into the tub for feeding. Non-feeding behaviors of such horses directed to such feeding tubs give rise to additional design challenges.

For example, juvenile horses within a stableyard commonly engage in kicking type play. Such horses may, on occasion, direct their kicking play against a feeding tub which is located within the stableyard. Upon a juvenile horse's kick toward or stomp upon such feeding tub, the tub commonly crushes or deforms, threatening breakage or destruction of the tub. Such playful kicking or stomping also threatens spillage of the animal feed contents of the tub onto the ground. Older horses within the stableyard may similarly engage in tub stomping and kicking behaviors as a result of frustration or boredom, similarly threatening damage to the tub and spillage of horse feed.

The instant inventive animal feeder solves or ameliorates the animal feed tub problems and defects discussed above by specially adapting floor and side wall components of the feed tub to enhance structural rigidity of the tub while providing an automatic self-righting function.

### BRIEF SUMMARY OF THE INVENTION

A first structural component of the instant inventive animal feeder comprises an annularly extending sidewall component. In a preferred embodiment, the annularly extending sidewall is composed of durable plastic. The upper end of the annularly extending sidewall preferably forms a circular upper opening which, for purposes discussed below, has a diameter of at least 18 inches. In a preferred embodiment, the upper end of the annularly extending sidewall forms a structural strength enhancing ridge or lip.

The instant inventive animal feeder preferably further comprises a multiply functioning truss component which is connected operatively to and spans across the lower end of the annularly extending sidewall. The feeder's truss component preferably comprises a substantially planar top chord element in combination with an underlying and downwardly curved bottom chord component. Circular outer ends of the trusses top and bottom chord components preferably meet at and are fixedly attached via whole formations with the lower end of the annually extending sidewall.

In the preferred embodiment, the top and bottom chords of the tub's truss component form and function as upper and lower boundaries or walls which define a ballast fill receiving cavity whose function is further described below.

An average horse's head has an 8-inch width, a 12-inch height, and a 28-inch length. If stableyard tub feeder had an upper opening diameter less than 18 inches, a downward insertion of such average horse's head into such narrow diameter opening would leave only approximately three inches of clearance between the surfaces of the horse's head and the inner surfaces of the tub's side wall. Where the space into which a horse must insert its head in order to feed is overly tight or small, the horse may typically shy away from or resist feeding from such opening. Accordingly, a preferred embodiment of the instant inventive tub feeder sizes its upper opening to have a diameter greater than 18 inches. The instant inventive feeder's preferred greater than 18 inches upper opening diameter additionally beneficially facilitates a horse's downwardly and forwardly angled view of the contents of the feeder from stableyard areas surrounding the feeder.

As indicated above, both juvenile horses and mature horses may, on occasion, engage in kicking and stomping behaviors directed against feeder tubs. The instant invention's preferred greater than 18 inches diameter upper opening size may undesirably expose the feeder to an enhanced risk of crushing and deformation damage resulting from such kicking or stomping behaviors. As the overall size of the feeder tub is increased, and as materials economy and weight economies are pursued, the preferred increased diameter and size of the feeder tub may undesirably expose the tub to an increased risk of kicking and stomping damage. The instant invention's lower truss configured floor enhances structural rigidity while simultaneously forming and defining a ballast fill receiving space. Such configuration also resists crushing and kicking deformations while economically minimizing materials usage and weight. Ballast fill within the space or cavity formed by top and bottom chord's of the truss operatively reinforces the truss chords in the manner of a truss web while performing a tub self-righting function. Toppling of the tub is resisted or reversed by the self-righting ballast fill which works in combination with the truss's underlying downwardly curved rocker configured bottom chord for gravity actuated righting of the tub.

Accordingly, objects of the instant invention include the provision of an animal feeder which incorporates structures as described above, and which arranges those structures in relation to each other in manners described above for the performance of beneficial functions as described above.

Other and further objects, benefits, and advantages of the instant invention will become known to those skilled in the art upon review of the detailed description which follows, and upon review of the appended drawings.

### BRIEF DESCRIPTION OF DRAWINGS

FIG. 1 is a perspective view of the instant inventive animal feeder.

FIG. 2 is a sectional view as indicated in FIG. 1, the view of FIG. 2 additionally showing contained animal feed, and showing an inserted horse head.

FIG. 3 is an upper plan view of the structure of FIG. 1.

FIG. 4 re-depicts the structure of FIG. 2, the view of FIG. 4 showing a reorientation of the feeder, and showing an impinging horse hoof.

FIG. 5 presents an alternate configuration of the structure depicted in FIG. 4.

FIG. 6 re-depicts structures appearing in FIG. 2.

FIG. 7 presents an alternate orientation of the structure depicted in FIG. 6.

### DETAILED DESCRIPTION OF THE INVENTION

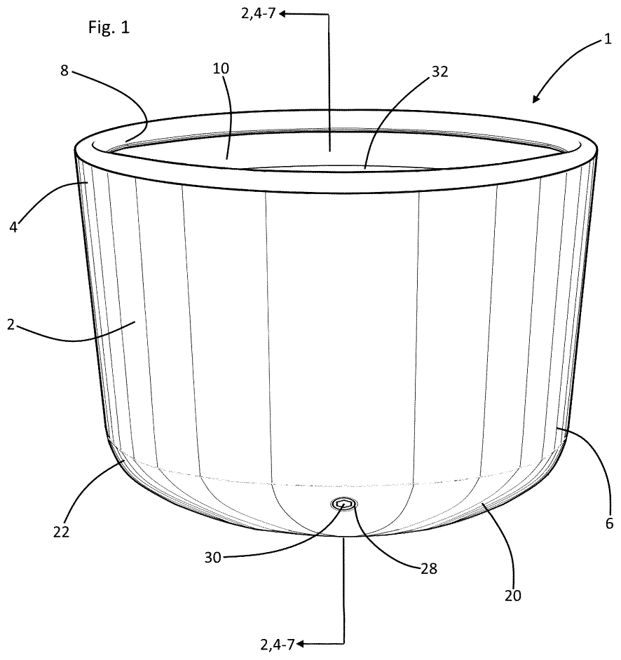

Referring now to the drawings, and in particular to FIG. 1, a tub configuration of the instant inventive animal feeder is referred to generally by reference arrow 1. The feeder 1 has an annularly extending sidewall 2, which has upper and lower ends 4 and 6. In a preferred embodiment, the annularly extending sidewall 2 is composed of a thermoplastic polymer such as high-density polyethylene plastic, polypropylene plastic, or a polypropylene copolymer. The sidewall 2 may suitably be alternatively composed of metal or fiberglass. The upper end 4 of the sidewall 2 preferably forms a substantially circular upper opening 10, and, for purposes of structural reinforcement and breakage resistance, the sidewall's upper end 4 forms an annularly and inwardly extending lip 8.

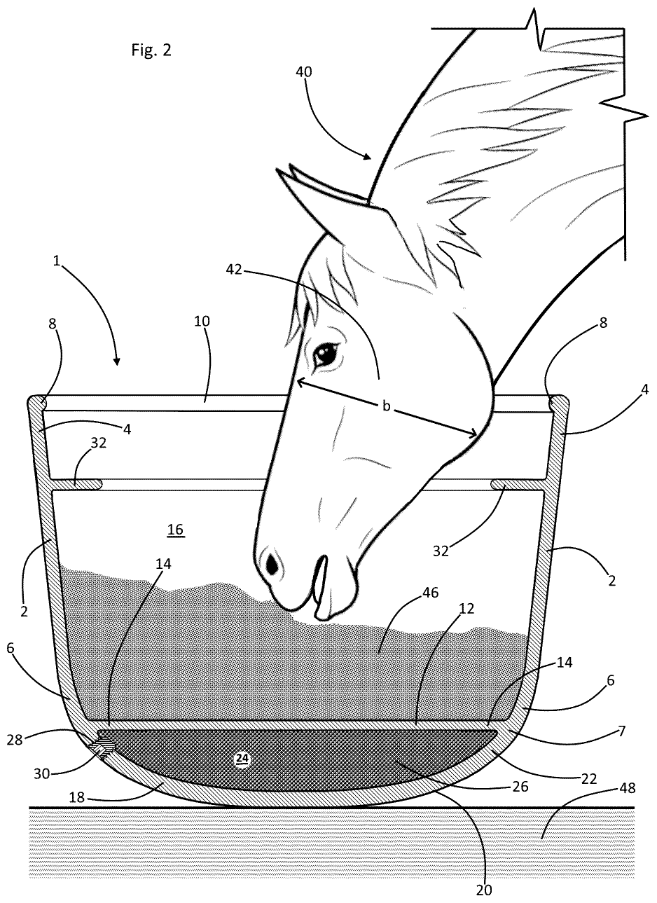

Referring further simultaneously to FIG. 2, the sidewall 2 annularly surrounds, forms, and defines an upwardly opening interior feed retaining space 16, such space being accessible by, for example, a horse 40 via downward extension of its head 42 into and through the upper opening 10. The lower end of the feed space 16 is preferably closed by a truss system or assembly 12,18 which comprises an upper or top chord 12 and a lower or bottom chord 18. The top chord component 12 is planar, extending continuously and substantially horizontally to the lower end 6 of the side wall 4, such chord preferably being configured in the form of a flat and circular disc having a radially outer end 14. The flat planar configuration of the top chord 12 enhances its ability to function as rigidity enhancing truss component.

The bottom chord component 18 of the instant invention's truss configured lower closure preferably arcuately curves downwardly so that it's lower surface 20 constitutes and may function as a rocker. Similarly with the preferred circular configuration of the top chord 12, the radially outer end 22 of the bottom chord 18 is circular. The structural combination of the inventive tub's sidewall 2, top chord 12, and bottom chord 18 preferably includes an annular and circumferentially extending juncture 7 which constitutes a whole formation of the lower end 6 of the side wall 2, the outer end 14 of the top chord 12, and of the outer end 22 of the bottom chord 18. The preferred whole formation of the juncture 7 enhances the ability of chords' ability to perform their reinforcing function.

The inventive tub's truss functioning top and bottom chord components 12 and 18 advantageously form and define a ballast fill receiving cavity 24 which is upwardly closed by the top chord 12, and which is downwardly closed by the bottom chord 18, the cavity 24 being outwardly and peripherally closed by the wholly formed truss member juncture 7.

The cavity 24 is preferably filled by a weighted ballast material 26, such material suitably comprising sand, lead shot, steel shot, ground or pulverized stone, granulated metal or concrete. To allow the introduction of the ballast 26 into the cavity 24, a fill port 28 is provided, such port extending through the bottom chord 22 at or near such chord's outer periphery. In a preferred embodiment, the fill port 28 is lined by is internal helical threads, which adapt the port for receipt of an externally helically threaded plug 30.

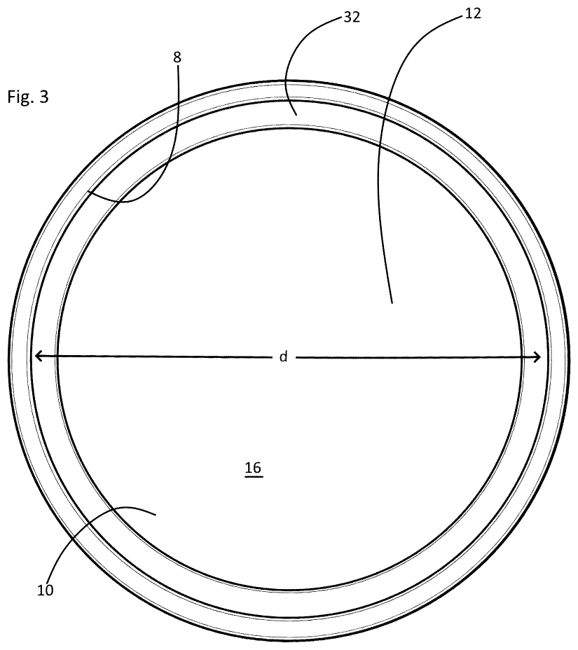

Referring to FIGS. 2 and 3, the horse 40 has a head 42 whose average height “b” is approximately 12 inches. It may be seen that the diameter “d” of the tub's opening 10 is more than twice such average 12-inch dimension “b”, such preferred tub opening dimension “d” allowing ample clearance between the surfaces of the horse's head and the inner wall surfaces of the tub 1. Horses are, in general, hesitant to insert their head into small openings or apertures. Accordingly, the opening 10 of the instant inventive tub 1 preferably has a minimum diameter of 18 inches, such minimum opening dimension assuring sufficient side wall clearances for comfortable receipt of an average horse's head for feeding. The preferred 18-inch minimum opening diameter also advantageously allows the horse 40 to view feed 46 within space 16 from locations about the periphery of the tub.

The preferred large diameter sizing of the inventive tub 1 to include an upper opening dimension “d” in excess of 18 inches necessarily and commensurately increases the size and dimensions of the tub's sidewall 2 and floor structures 12 and 18.

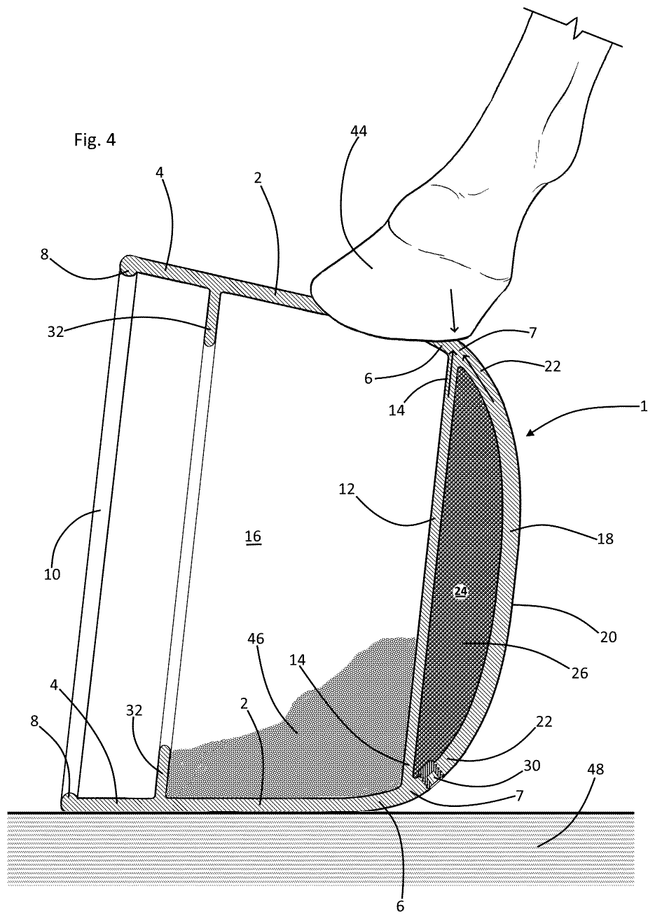

Such resultant size increases tend to subject the tub to damage resulting from kicks or stomping actions directed by horses against the tub. For example, referring to FIGS. 2 and 4, the horse 40 may laterally topple the tub 1, and may thereafter stomp against the tub, causing the horse's hoof 44 to downwardly impinge against the tub's sidewall 2. As shown by force vector arrows drawn upon FIG. 4, the top and bottom chord components 12 and 18 resist such hoof imposed crushing force, acting in the manner of a structure reinforcing truss. The truss configured floor 12, 18 resists crushing deformation more effectively than a conventional single layer floor while reducing material composition and weight.

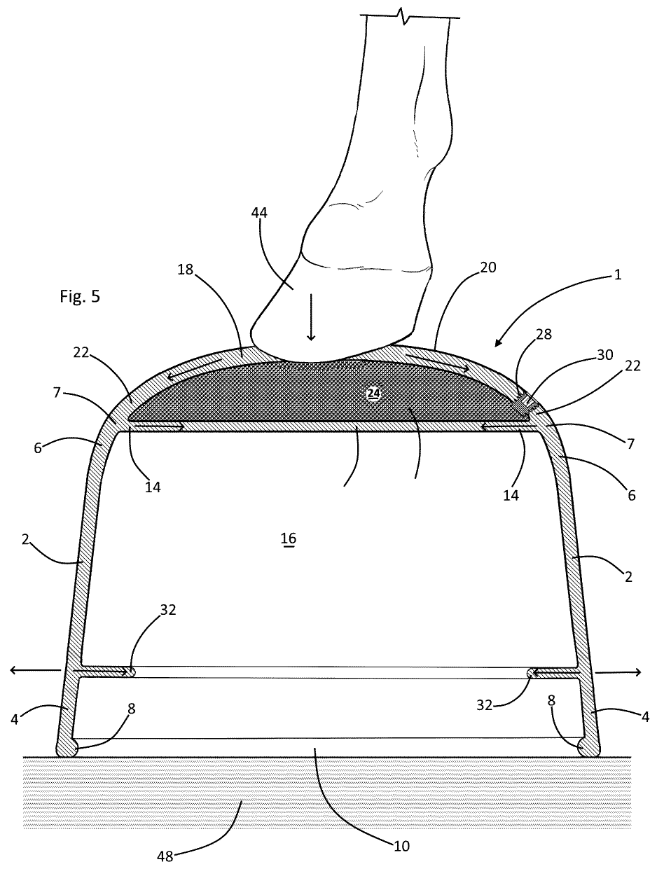

Referring further to FIG. 5, upon further toppling of the tub 1, and upon a downward application of hoof 44 against the upturned bottom chord 18, the truss configured top and bottom chords 12 and 18 similarly resist crushing action imposed by the hoof 44 in the manner of a structural reinforcing truss. The FIG. 5 configuration provides a structural analogy with a common “A” framed truss, with the inventive bottom chord 18 sloping upwardly to meet at a central apex. In the FIG. 5 configuration, the fill 26 within cavity 24 advantageously functions as and constitutes a truss web component, further distributing crushing forces between and among the top and bottom chords 12 and 18.

Referring to FIG. 4, the annularly extending sidewall 2 is preferably configured to present an inwardly extending and cantilevering flange 32. Such flange further resists inward crushing forces exerted by the horse's hoof 44, as shown by force vector arrows drawn upon the flange 32. The preferably provided flange 32 additionally or dually functions as a feed retention component. As shown in FIG. 4, a horse-induced toppling of the tub from the upright FIG. 2 orientation to the laterally toppled FIG. 4 position may tend to undesirably spill the feed 46 out of the tub's upper opening 10. In addition to its performance of the sidewall crushing resistance function, the flange 32 prevents spillage of the feed 46 onto the ground. In the preferred embodiment, the flange 32 is positioned between the lip 8 and the top chord 12 so that the lip 9 overlies the flange 32 and so that the bottom chord 12 underlies the flange 32.

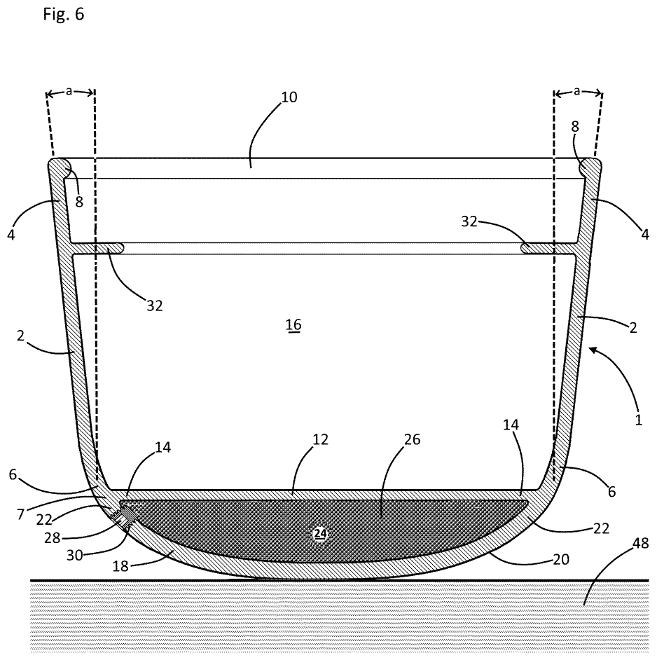

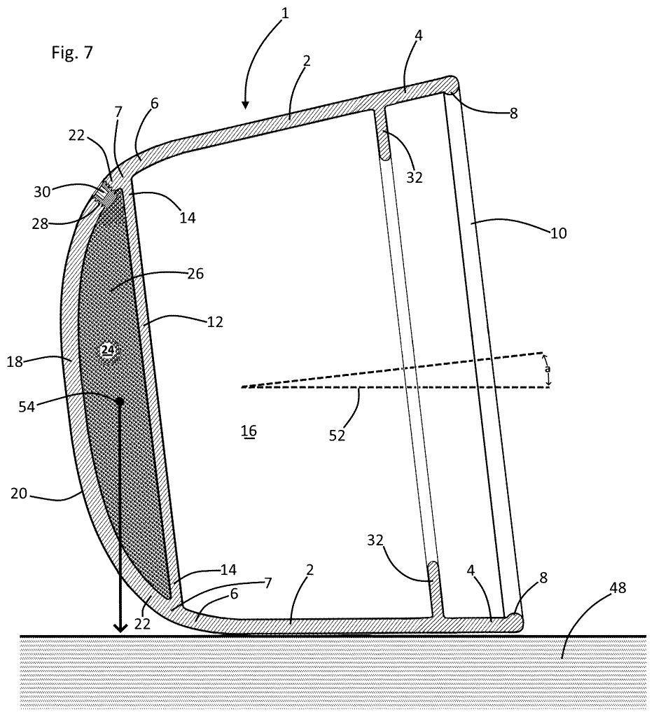

Referring simultaneously to FIGS. 5 and 6, it may be seen that the annularly extending sidewall 2 flares outwardly at an acute angle “a”, away from a vertical orientation line 50. Such angle “a” is preferably between 3 degrees and 20 degrees. Upon a horse-induced toppling of the tub 1 from its upright FIG. 6 configuration to the laterally toppled configuration of FIG. 7, such wall angle “a” assures that the tub 1 will tilt at such angle “a” upwardly away from a horizontal line 52 which is parallel with the ground 48. Such outward flare angle “a” of the sides 2 assures that the center of gravity 54 of the tub downwardly underlies the top chord 12. Such low center of gravity placement allows the ballast to fill 26 to actuate the rocker function of the lower surface 20 of the downwardly curved bottom chord 18, advantageously automatically righting tub 1 to its upright configuration as in FIG. 6 upon the horse-induced tub toppling.

While the principles of the invention have been made clear in the above illustrative embodiment, those skilled in the art may make modifications to the structure, arrangement, portions and components of the invention without departing from those principles. Accordingly, it is intended that the description and drawings be interpreted as illustrative and not in the limiting sense, and that the invention be given a scope commensurate with the appended claims.

1. A tub feeder for feeding horses, the tub feeder comprising:
a. an annularly extending sidewall, said sidewall having upper and lower ends;
b. an upper opening defined by the upper end of the annularly extending sidewall; and
c. a truss connected operatively to the lower end of the annularly extending side wall, wherein the truss comprises a planar top chord, and wherein the truss comprises a downwardly curved bottom chord.

2. The tub feeder of claim 1, further comprising a cavity, the cavity being positioned between the planar top chord and the downwardly curved button chord.

3. The tub feeder of claim 2, further comprising ballast within cavity.

4. The tub feeder of claim 3, wherein the upper end of the annularly extending side wall has a diameter greater than 18 inches.

5. The tub feeder of claim 4, wherein the planar top chord and the downwardly curved bottom chord have circular outer ends.

6. The tub feeder of claim 5, wherein the circular outer ends of the top and bottom chords are formed wholly with the lower end of the annularly extending sidewall.

7. The tub feeder of claim 6, further comprising a fill port communicating with the cavity.

8. The tub feeder of claim 7, further comprising a plug within the fill port.

9. The tub feeder of claim 6, wherein the downwardly curved bottom chord has a lower surface, and wherein said lower surface comprises a rocker.

10. The tub feeder of claim 9, wherein the planar top chord extends substantially horizontally.

11. The tub feeder of claim 10, wherein the annularly extending side wall has an inner surface, and further comprising a flange supporting said inner surface, the flange being positioned between said sidewall's upper and lower ends.

12. The tub feeder of claim 11, wherein the flange cantilevers inwardly.

13. The tub feeder of claim 12, wherein the annularly extending sidewall flares outwardly at an acute angle away from vertical.

14. The tub feeder of claim 13, wherein the acute angle away from vertical is between 3 degrees and 20 degrees.

15. The tub feeder of claim 14, further comprising a reinforcement lip fixedly attached to or formed wholly with the upper end of the annularly extending sidewall.

16. The tub feeder of claim 15, wherein the reinforcement lip extends radially inwardly.

17. The tub feeder of claim 3, wherein the ballast is selected from a group of materials selected from sand, gravel, crushed rock, shot, granulated metal, and concrete.

18. The tub feeder of claim 17, wherein the top and bottom chords, the ballast, and the annularly extending sidewall have a center of gravity, and wherein said center of gravity is positioned below the lower end of the annularly extending sidewall.
